(19) United States
(12) Patent Application Publication
(10) Pub. No.: US 2005/0050196 A1
(43) Pub. Date: Mar. 3, 2005

(54) Method and apparatus for managing and graphically representing elements in a network

(75) Inventors: Nageshwar Aita, Somerset, NJ (US); Ranga Rao Baireddy, Toms River, NJ (US); Mehar S. Kalaparthy, Morganville, NJ (US); Sudha Piddaparti, Hazlet, NJ (US); Michael Joseph Szoka, Jackson, NJ (US); Jaspal S. Virdee, Marlboro, NJ (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: LUCENT TECHNOLOGIES INC.

(21) Appl. No.: 10/648,625

(22) Filed: Aug. 25, 2003

(51) Int. Cl. G06F 15/173; G06F 15/177

(52) U.S. Cl. 709/224; 709/223; 709/220; 709/226; 709/239; 709/242

(57) ABSTRACT

Method and apparatus for managing a communications network by graphically representing network elements within a network as a plurality of network element objects, graphically representing communications links between two network elements as a bridge object and graphically representing the status of cross-connects within a network element as an icon displayed on each of said linked network element objects. The icon is a set of colors, each color corresponding to a particular connection state of each communication link within each network element.

### FIELD OF THE INVENTION

The invention relates to the field of communication systems and, more specifically, to the management and graphical representation of a communication system comprising a relatively large number of nodes and connections.

### BACKGROUND OF THE INVENTION

Telecommunication networks and other networks are increasing in both size and complexity. Unfortunately, as such networks increase in size, the network management function also increases in complexity. This means that critical tasks such as provisioning (allocating resources to form a communications link), restoration, reinstatement and the like must be completed in a reasonable time using network management tools available to a network manager.

In a provisioning mode, for example, an operator specifies all details of a circuit such as end points, appropriate links, time slots and network elements to establish a managed connection. The provisioning mode allows the operator to select a particular circuit for routing a communication, such as a telephone call or other communication. The operator interacts with the system via a graphical user interface (GUI) that represents the network including the circuit to be provisioned.

Unfortunately, in current networks, the GUI's are limited and customers are required to view event or fault lists to determine where the faults exist on the managed connection. This implies the connection conditions need to be pre-satisfied, (i.e., the customer has identified the faults during the connection build or discovers the problems one at time in the connection build phase). This is a tedious and time consuming process resulting in longer set-up times for connections.

### SUMMARY OF THE INVENTION

These and other deficiencies of the prior art are addressed by the present invention of a method for provisioning a circuit between a starting network element and an ending network element. The method includes the steps of graphically representing network elements within a network as a plurality of network element objects, graphically representing communications links between two network elements as a bridge object and graphically representing the status of cross-connections within each network element as an icon or links between ports displayed on each of said linked network element objects. The icon or links between connecting ports may be represented by a set of colors, a set of images, shapes, symbols, objects, text or any combination thereof. In one embodiment of the invention, a set of colors is employed consisting of a list of seven colors, each color corresponding to a particular cross-connection state within each network element.

A graphical user interface (GUI) for use in provisioning a circuit in accordance with the present invention includes a plurality of network element objects, each network element object representing a respective element within a network and having a status icon or links between ports associated within the network element object; a plurality of bridge objects, representing a respective communications channel within the network such that when the network element corresponding to the selected network object is selected for use in a circuit; its corresponding status icon or link displays information as to the status of a communications channel within the network element and a second network element. Each bridge object has at least one communications link object, each communications link object includes at least one channel object, each channel object representing the communication channel. The status icon is selected from a set of colors, shapes, symbols, objects or text. In one embodiment of the invention, the set of colors represents the status of communications channel within that network element.

### BRIEF DESCRIPTION OF THE DRAWINGS

FIG. 1 depicts a high-level block diagram of a communications system including the present invention;

FIG. 2 depicts a high-level block diagram of a network manager suitable for use in the communications system of FIG. 1;

FIG. 3 depicts a graphical representation of a communications network divided into areas; and

FIG. 4 depicts a graphical representation of parts of the communications network sharing their connection status.

To facilitate understanding, identical reference numerals have been used, where possible, to designate identical elements that are common to the figures.

### DETAILED DESCRIPTION OF THE INVENTION

The subject invention will be described within the context of a telecommunication system comprising a large number of network elements or nodes. It will be appreciated by those skilled in the art that any form of communication may be utilized, such as telecommunication, data communication, streaming media communication and the like. Thus, it is contemplated by the inventors that the subject invention has broad applicability beyond the telecommunication network described herein. Specifically, the subject invention is applicable to the management of any multi-node communication network, regardless of the number of network elements deployed in the communication network or the type of communication links utilized by the communication network.

The invention advantageously simplifies the representation and management functions needed to perform rapid setup and tear down of network connections in a build stage as well as facilitating fault diagnosis for a network. Provisioning comprises the process of selecting the start and end points (nodes) of a communication path, optionally selecting some or all of the nodes and links connecting the start and end nodes, finding the “best” communication path between the start and end nodes, and generating the commands to each of the nodes within the “best” path such that cross-connects within the network cause the path to be formed such that traffic may flow through the provisioned circuit. Restoration is the process of selecting an alternate path in the event of a break in the originally provisioned circuit. In response to such a break, commands are generated to cause new cross-connections in network elements to create the alternate communications path and to cause affected network elements forming the initially provisioned communications path to disconnect. Reinstatement is the process of restoring the originally provisioned circuit after the circuit breaks or other anomaly resulting in a restoration process has been resolved.

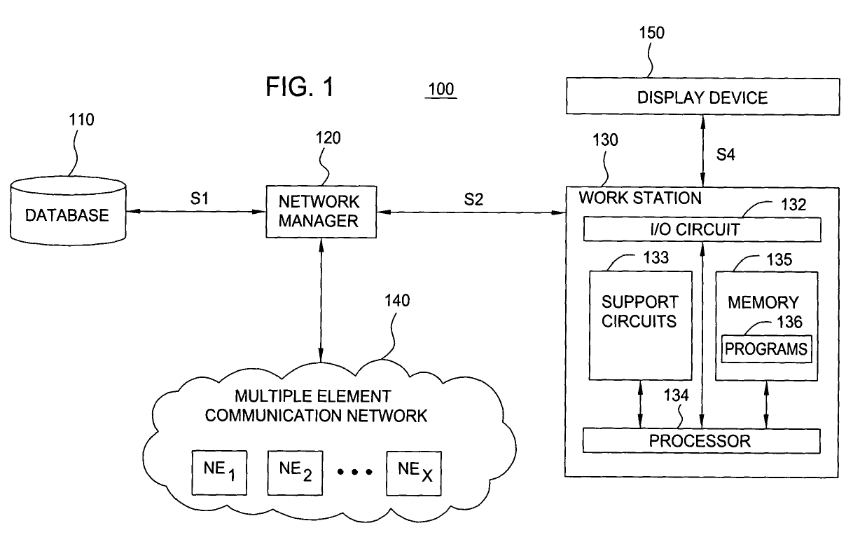

FIG. 1 depicts a high-level block diagram of a communications system 100 including the present invention. Specifically, the communications system 100 comprises a database 110, a network manager or controller 120, a workstation 130 and a multi-node communication network 140.

The multi-node communication network 140 comprises a plurality of network elements (NE) denoted as network elements NE₁ through NEₓ (collectively network elements NE). Each communication to be transmitted from a start network element or start-node to an end network element or end-node requires the determination by the network manager 120 of an appropriate communications path. Advantageously, the subject invention operates to simplify the graphical representation of the network and facilitate rapid provisioning and fault detection operations.

The multi-node communication network 140 is coupled to the network manager 120 via signal path S3. The network manager 120 is used to manage various network operations such as the routing of communications and other functions.

The database 110 may comprise a mass storage device, such as a redundant array of inexpensive devices (RAID) or other mass storage device. All that is necessary is that the data base 110 be able to communicate with the network manager 120 in a manner facilitating the storage and retrieval of information, such as characterization and control information pertaining to the multi-node communication network 140.

The workstation 130 communicates with the network manager 120 via, for example, a computer network. It will be appreciated by those skilled in the art that more or fewer workstations 130 may be provided within the communication system 100 of FIG. 1. The workstations 130 comprise, for example, a terminal used by a network operator to request the provisioning of communication circuits between start-nodes and end-nodes in response to, for example, requests for such circuits from network users. The workstations 130 may also comprise interfaces between network system users and customers and the network manager 120.

The network manager 120 and database 110 of the communications system 100 of FIG. 1 are depicted as separate functional entities. However, it will be appreciated by those skilled in the art that the network manager 120 and database 110 may be combined within a single functional entity. Thus, the network manager 120 and database 110 may be operably combined to form a network management apparatus suitable for managing the multi-node communication network 140 according to the present invention.

In one embodiment of the invention, the network manager 120 comprises, illustratively, an Optical Management System manufactured by Lucent Technologies, Inc. of Murray Hill, N.J. In this embodiment, the network manager 120 implements network management layer functions according to, for example, the Telecommunications Management Network (TMN) standards which are incorporated herein by reference in their entirety. Thus, the network manager 120 is used to manage all element management systems and network elements within the communications system 100 of FIG. 1, both individually and as a set of network elements. The network manager 120 can include or be operatively coupled to various element management systems (not shown) according to the various management layer functions described in the TMN standard.

The workstation 130 generates graphical user interface (GUI) imagery that is displayed on the display device 150. The displayed imagery representing a network map is modified according to the present invention to represent the status of the cross-connects within network elements specified by a workstation operator. The exemplary work station 130 comprises a processor 134 as well as memory 135 for storing various programs 136. The processor 134 cooperates with conventional support circuitry 133 such as power supplies, clock circuits, cache memory and the like as well as circuits that assist in executing the software routines stored in the memory 135. As such, it is contemplated that some of the process steps discussed herein as software processes may be implemented within hardware, for example, as circuitry that cooperates with the processor 134 to perform various steps. The work station 130 contains input-output circuitry 132 that forms an interface between the various functional elements communicating with the work station 130.

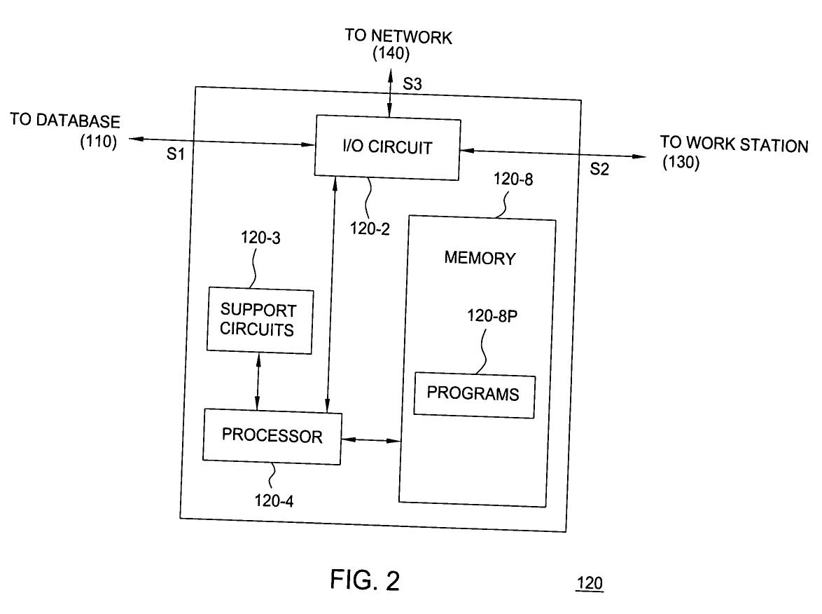

FIG. 2 depicts a high-level block diagram of a network manager or controller suitable for use in the communications system 100 of FIG. 1. Network manager 120 of the present invention communicates with the workstation 130 operated by, for example, network operators servicing customers requesting the provisioning or restoration of specific connections. Specifically, the exemplary network manager or controller 120 of FIG. 2 comprises a processor 120-4 as well as memory 120-8 for storing various network management and control programs 120-8P. The processor 120-4 cooperates with conventional support circuitry 120-3 such as power supplies, clock circuits, cache memory and the like as well as circuits that assist in executing the software routines stored in the memory 120-8. As such, it is contemplated that some of the process steps discussed herein as software processes may be implemented within hardware, for example, as circuitry that cooperates with the processor 120-4 to perform various steps. The network manager 120 also contains input-output circuitry 120-2 that forms an interface between the various functional elements communicating with the network manager 120. For example, in the embodiment of FIG. 1, the network manager 120 communicates with a data base 110 via a signal path S1, each of a plurality of work stations 130 via signal path S2, the communication network to be managed 140 via signal path S3, and a remote work station 132 via signal path S4.

Although the network manager 120 of FIG. 2 is depicted as a general purpose computer that is programmed to perform various network management functions in accordance with the present invention, the invention can be implemented in hardware as, for example, an application specific integrated circuit (ASIC). As such, the process steps described herein are intended to be broadly interpreted as being equivalently performed by software, hardware, or a combination thereof.

The graphical connectivity feature allows a work station user to graphically see the communications links, cross-connects within the network elements and network elements or nodes at the end of these communications links during the provisioning of circuits. The graphical connectivity feature enables the management system to determine various parameters associated with communications links as they are selected and connected, and update the graphical representation of the connectivity of these communications links dynamically for a user. Within the context of the graphical user interface, a graphical connectivity panel (GCP) (explained in greater detail below) is displayed on the display device 150 associated with the workstation 130. The graphical connectivity panel allows the user to graphically see selected links, cross-connects and nodes at the end of the selected links during the provisioning of circuits. The displayed graphical elements or icons representing physical elements within the network (such as nodes, links, channels, etc.) are updated dynamically as a circuit is built or provisioned. Similarly, link or circuit breakage and restoration within the monitored communications network is also graphically represented so that the status of these connections is easily determined.

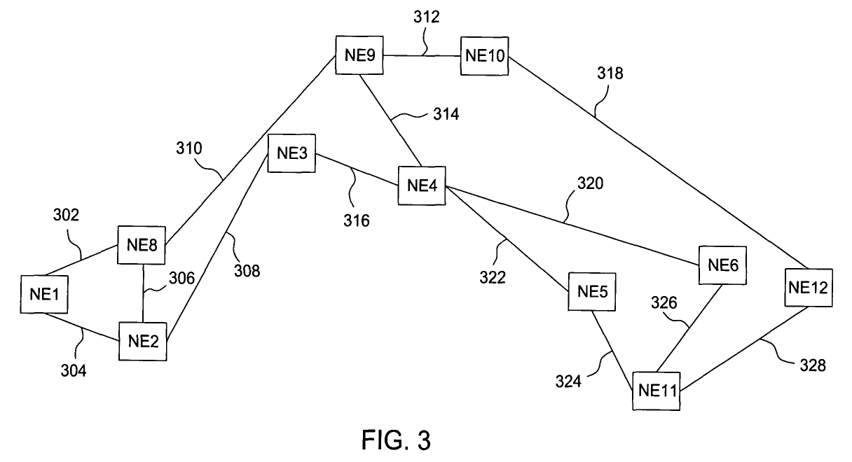

FIG. 3 depicts a graphical representation of a communications network (such as network 100) operated in accordance with an embodiment of the subject invention. A plurality of network elements are represented by network element objects denoted as NE1, NE2 . . . NE12. The network elements are connected to each other via a plurality of communication links represented by bridge objects (300's). Specifically, network elements NE1 and NE8 are connected via a first link 302. Network element NE1 and network element NE2 are connected via second link 304. Network element NE2 and network element NE8 are connected via third link 306. Network element NE2 and network element NE3 are connected via fourth link 308. Network element NE8 and network element NE9 are connected via fifth link 310. Network element NE9 and network NE10 are connected via sixth link 312. Network element NE9 and network element NE14 are connected via seventh link 314. Network element NE3 and network element NE4 are connected via eighth link 316. Network element NE10 and network element NE12 are connected via ninth link 318. Network element NE4 and network element NE6 are connected via tenth link 320. Network element NE4 and network element NE5 are connected via eleventh link 322. Network element NE5 and network element NE11 are connected via twelfth link 324. Network element NE11 and network element NE6 are connected via thirteenth link 326, and, finally, network element NE11 is connected to network element NE12 via fourteenth link 328.

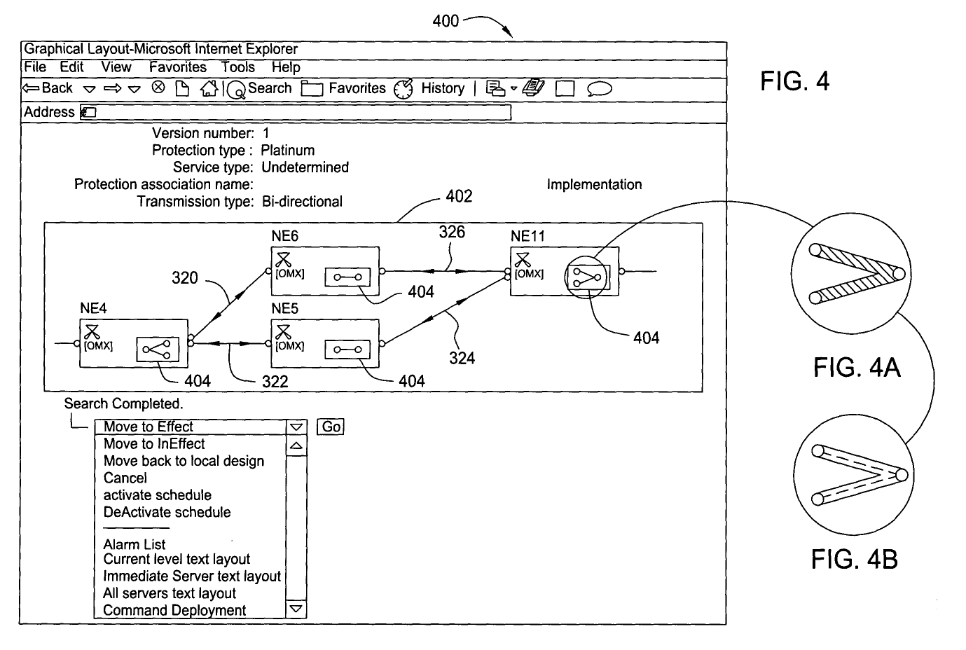

FIG. 4 depicts one embodiment of the GCP as a graphically represented connectivity panel 402 inside a network graphical layout software application window 400. In other words, in one embodiment of the invention, the communication links between the plurality of network elements are viewed in a dedicated application program for designing such links in a network managed system. The connectivity (graphical layout) panel 402 shows one or more network elements NEn and their respective communication links. Also contained within the graphical representation of each network element is a status icon or connecting links within network element 404. The status icon 404 provides the application user with information regarding the status of the cross-connection within the network elements that are graphically displayed in the window 402. For example, FIG. 4 depicts the graphical connectivity panel 402 displaying network elements NE4, NE5, NE6 and NE11 and their respective communication links 320, 322, 326 and 324 as described above with respect to FIG. 3. Additionally, each of the cross-connections is provided with a status identified by the status icon 404 in the graphical representation of each network element NEn so as to determine the status of that cross-connection.

In one embodiment, the status icon 404 is represented by at least one line (representing the cross-connection within a network element) with a specific color assigned to the lines to represent the status of the cross-connection. In greater detail and as seen at the insert FIG. 4a, a status icon 404 for network element NE11 is shown. Specifically, FIG. 4a shows the icon 404 represented in two green lines converging at a single point which is representative of two input/output ports of NE11 (seen at the left side of the NE11 graphical representation in connectivity panel 402) and a single output port (seen at the right side of the NE11 graphical representation). FIG. 4b shows the same status icon 404; this time with a color representation of gray. The assignment of colors for the status icons is one particular embodiment and is shown in greater detail by the following Table 1. Specifically, there are various states depending on the level of implementation of the cross-connect in the system as well as its status. Table 1 shows for one embodiment the resultant color that is assigned to each of the connection states to facilitate instant recognition of the state of the connection when viewing the connectivity panel 402.

TABLE 1
Cross-Connect state colors

| | | Color indication | |
|---|---|---|---|
| | | on “Link” of | |
| | | cross-connect | Link |
| Connection State | Cross-connect state | image | Color |
| Local Design | Local | Yes | Black |
| | Active (cross-connect | Yes | Green |
| | created at NE by | | |
| | CIT/EMS | | |
| Low Level | Local | Yes | Black |
| Design (MRP) | Active (cross-connect | Yes | Green |
| | created at NE by | | |
| | CIT/EMS) | | |
| | Pending | Yes | Grey |
| LLD Inprogress | Local | Yes | Black |
| | Active (cross-connect | Yes | Green |
| | created at NE by | | |
| | CIT/EMS) | | |
| | Pending | Yes | Grey |
| Implementation | Active | Yes | Green |
| Success | Partial | Yes | Red |
| | Improper disconnect | Yes | Orange |
| Implementation | Local (commands not | Yes | Black |
| Inprogress | sent) | | |
| | Active | Yes | Green |
| | Partial | Yes | Red |
| | Improper Disconnect | Yes | Orange |
| | Intent to Create | Yes | Cyan |
| | Intent to Delete | Yes | Magenta |
| Implementation | Local (commands not | Yes | Black |
| Fail | sent) | | |
| | Active | Yes | Green |
| | Partial | Yes | Red |
| | Improper Disconnect | Yes | Orange |
| | Intent to Create | Yes | Cyan |
| | Intent to Delete | Yes | Magenta |
| InEffect Success | Active | Yes | Green |
| | Improper Disconnect | Yes | Orange |

The above cross-connect states are shown when the connection type exists in the system Database. The cross-connect state of “Improper Disconnect” occurs when implementation has created and/or activated the cross-connect but is deleted outside the scope of the management system. This will not be reflected when implementation is to disconnect from the management system. One skilled in the art will realize that color is not the sole means of identifying status for the icons and any one of a number of alternate means can be employed. For example, various shapes, symbols, objects or text may be used individually or in any combination in the connectivity panel to make the appropriate representation in the icon 404.

The advantages of the subject invention are easily seen by way of example of implementing same. For example, the network manager 120 of communication system 100 of FIG. 1 has the relevant information regarding the characteristics of network elements and cross-connections either in its memory 120-8 or in a remote location such as database 110. Additionally, various network elements may also report their characteristics to the network manager 120 during provisioning. When a user provisions (creates or deletes or moves to another connection state amongst one or more network elements) a connection from the network manager 120, the network manager 120 will check the cross-connection state reported by the network elements. This information is subsequently provided to a neighboring work station 130 and displayed on its respective display device 150 in order to display the known cross-connection states for each node (network element) in the system.

More specifically, the display device 150 will display a screen such as the screen 400 shown in FIG. 4 in which a connection panel 402 details the information (in a graphical format) of each network element and (such as NE4 AND NE6) and its corresponding cross-connection (cross-connection 404 of either NE4 or NE6) while displaying the status of such cross-connection in the status icon 404. In a provisioning mode, a workstation user selects a start-node (i.e., a first network element and in one example NE4) and an end-node (i.e., a second network element and in one example NE11) on the graphically displayed network map. Since the invention provides a graphical display, the start-node, end-node and any intermediate nodes (for example, network elements NE6 and NE5) that may constitute a communication path to be built (or torn down) is displayed. The user then selects each cross-connect in a communications path between the start-node and end-node and sends a request to a host computer to retrieve a list of spare channels on each selected cross-connect between nodes.

Selecting a connection presents a user with the list of spare channels, displayed in the table. The user then selects a channel to be used in forming the provisioned circuit: user repeats this for other cross-connects. After selecting sufficient channels to provision the circuit, a request to provision is transmitted to the host. The user then selects the required time slots using the GUI. This procedure is repeated for each cross-connect in the communications path to be provisioned, which may comprise up to 80 links or more.

After selecting the time slot for each link between the start-node and end-node, the host computer arranges the selected links (i.e., the selected channel and time slot for each link) in the correct order and sends commands to each network element which, when implemented, result in the provisioning of the cross-connects and other network elements forming the complete communication path between the start-node and end-node. At this point, traffic may flow through the circuit. As a result, finding connection faults can be accomplished in a much more rapid and user friendly manner. That is, with a graphical interface indicating the specific status of each cross-connection, diagnosing becomes much simpler and much less intense than consulting event or fault lists or performing field diagnostics.

Although various embodiments, which incorporate the teachings of the present invention, have been shown and described in detail herein, those skilled in the art can readily devise many other varied embodiments that still incorporate these teachings.

1. A method for provisioning a circuit via a plurality of network elements comprising:
(a) graphically representing said network elements within a network as a plurality of network element objects;
(b) graphically representing a communications link between two network elements as a bridge object disposed between two of said plurality of network element objects; and
(c) graphically representing the status of cross-connection links within said network elements as an icon displayed on each of said linked network element objects; wherein
said network element objects and bridge objects may be manipulated to form a graphical representation of a desired circuit.

2. The method of claim 1, wherein the icon is selected from the group consisting of a set of colors, a set of images, shapes, symbols, objects, and text.

3. The method of claim 2, wherein the icon is a set of colors and each color of said set corresponds to a particular connection state and cross-connection state within each network element.

4. The method of claim 3 wherein the set of colors consists of a list of seven colors.

5. The method of claim 1, wherein each bridge object has at least one communications link, each communications link comprising at least one channel for establishing a communication path between two of the plurality of network elements.

6. A graphical user interface (GUI), comprising:
a plurality of network element objects, each network element object representing a respective element within a network and having a status icon associated with the network element object;
a plurality of bridge objects, representing a respective communications channel within the network; wherein:
in response to a user selection of a network element object, the network element corresponding to the selected network object is selected for use in a circuit; and its corresponding status icon displays information as to the status of a communications channel between the network element and a second network element.

7. The GUI of claim 6, wherein each bridge object further comprises at least one communications link object, each communications link object comprising at least one channel object, each channel object representing the communication channel.

8. The GUI of claim 6, wherein the status icon is selected from the group consisting of colors, shapes, symbols, objects and text.

9. The GUI of claim 8, wherein the colors represent the status of a communications channel between the first network element and the second network element.

10. The GUI of claim 9, wherein a first color represents a cross-connection locally in a management system database not yet set to a network element.

11. The GUI of claim 10, wherein said first color is black.

12. The GUI of claim 9, wherein a second color represents an active connection created by CIT/EMS.

13. The GUI of color 12, wherein said second color is green.

14. The GUI of claim 9, wherein a third color represents a pending communications channel.

15. The GUI of claim 14, wherein said third color is gray.

16. The GUI of claim 9, wherein a fourth color represents a partial communications channel state.

17. The GUI of claim 16, wherein said fourth color is red.

18. The GUI of claim 9, wherein a fifth color represents an improper disconnect state of the communications channel.

19. The GUI of claim 18, wherein said fifth color is orange.

20. The GUI of claim 9, wherein a sixth color represents an “intent to delete” state of the communications channel.

21. The GUI of claim 20, wherein said sixth color is magenta.
